(19) United States
(12) Patent Application Publication
(10) Pub. No.: US 2011/0267292 A1
(43) Pub. Date: Nov. 3, 2011

(54) METHOD FOR SIMULTANEOUSLY OPERATING MULTIPLE POINTERS ON ELECTROMAGNETIC POSITION DETECTION APPARATUS

(75) Inventor: YUN-HSIANG YEH, Miaoli (TW)

(73) Assignee: WALTOP INTERNATIONAL CORPORATION, HSIN-CHU CITY (TW)

(21) Appl. No.: 13/029,037

(22) Filed: Feb. 16, 2011

(30) Foreign Application Priority Data
Apr. 29, 2010 (TW) 099113659

(51) Int. Cl. G06F 3/041

(52) U.S. Cl. 345/173

(57) ABSTRACT

A method for simultaneously operating multiple pointers on an electromagnetic position detection apparatus is disclosed. The method comprises the following steps. First of all, at least one pointer is provided on the electromagnetic detecting apparatus. Next a scanning process is performed to determine whether a first pointer is recognized. Then if the first pointer is recognized, an electromagnetic power with frequency A is emitted and an electromagnetic signal of the first pointer is received. Next the coordinate of the first pointer is calculated. Next a scanning process is performed to determine whether a second pointer is recognized. Then if the second pointer is recognized, an electromagnetic power with frequency B is emitted and an electromagnetic signal of the second pointer is received. Finally, the coordinate of the second pointer is calculated and the above mentioned steps are repeated.

### FIELD OF INVENTION

The present invention relates to a method and an apparatus for electromagnetic position detection, and more particularly to a method for simultaneously operating multiple pointers on an electromagnetic position detection apparatus and the electromagnetic position detection apparatus.

### DESCRIPTION OF THE PRIOR ART

Conventional electromagnetic position detection apparatuses, such as digitizers, which use multiple pointers, such as styluses or electric pens, usually utilize electromagnetic signals with different frequencies to resonate with the resonance circuits of the pointers so as to transmit and receive electromagnetic signals between the antennas or sensor coils of the electromagnetic position detection apparatus and the resonance circuit of the pointer without mutual interference, and the multiple pointers can be operated simultaneously on the electromagnetic position detection apparatus. However, using signals with separate frequencies for simultaneously operating the pointers must add hardware components to generate the signals with different frequencies. Conventional electromagnetic position detection apparatus using signals with separate frequencies for simultaneously operating the pointers is disclosed in U.S. Pat. No. 5,466,896. The cost is thus increased due to additional hardware and so is the complexity.

In order to solve the above-mentioned drawbacks of the conventional electromagnetic position detection apparatus using signals with separate frequencies for simultaneously operating the pointers, a new method for simultaneously operating multiple pointers on an electromagnetic position detection apparatus and the electromagnetic position detection apparatus are thus provided.

### SUMMARY OF THE INVENTION

An object of the present invention is to provide a method and an apparatus which use the programming of the firmware of the micro controller to process signals transmitting and receiving between multiple pointers and an electromagnetic position detection apparatus via time divisional protocols such that only one pointer interacts with the electromagnetic position detection apparatus at one time frame to locate the coordinates of the pointer without mutual interferences between the pointers. Therefore, multiple pointers can be operated on the electromagnetic position detection apparatus without significantly increasing the cost.

According to the object of the present invention, a method for operating multiple pointers on an electromagnetic position detection apparatus is provided. The method comprises the following steps. First of all, at least one pointer on the electromagnetic detecting apparatus is provided. Then a first scanning process is performed to determine whether a first pointer is recognized. Next an electromagnetic power with frequency A is emitted and electromagnetic signals of the first pointer are received if the first pointer is recognized. Then coordinates of the first pointer are calculated. Next a second scanning process is performed to determine whether a second pointer is recognized. Then an electromagnetic power with frequency B is emitted and electromagnetic signals of the second pointer are received if the second pointer is recognized. Finally, the coordinates of the second pointer are calculated. The steps set forth are repeated via time divisional protocols to operate multiple pointers simultaneously on the electromagnetic detecting apparatus.

According to the object of the present invention, an electromagnetic position detection system for operating multiple pointers thereon is provided. The system comprises a plurality of sensor coils on an antenna board, at least two pointers, a micro controller and a signal processing circuit. The pointers transmit signals to the sensor coils with a frequency and receive electromagnetic powers with individual frequencies. The micro controller controls the sensor coils to transmit and receive the signals, wherein the micro controller controls the sensor coils sequentially and alternately emitting electromagnetic powers each with an individual frequency to the pointers, the pointers are set to receive the electromagnetic powers with different frequencies so that only one pointer receives the electromagnetic power at one time frame. The signal processing circuit processes and analyzes the signals received by the sensor coils, and transmits the processed signals to the micro controller to calculate coordinates of the pointers.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1 shows a block diagram of an electromagnetic position detection apparatus according to one embodiment of the invention.

FIG. 2A shows a flow chart of a method for simultaneously operating multiple pointers on an electromagnetic position detection apparatus according to one embodiment of the present invention.

FIG. 2B shows a flow chart of a method for simultaneously operating multiple pointers on an electromagnetic position detection apparatus according to another embodiment of the present invention.

FIG. 3 shows flow A and flow B alternately and repeatedly performed in order to simultaneously operate the pointers.

FIGS. 4 and 5 show two embodiments of power loops for emitting the electromagnetic power respectively.

FIGS. 6A and 6D show a schematic view of two pointers simultaneously operating on an electromagnetic position detection apparatus according to one embodiment of the invention respectively.

FIGS. 6B, 6C, 6E and 6F show a schematic view of only one pointer operating on an electromagnetic position detection apparatus according to one embodiment of the invention respectively.

### DESCRIPTION OF THE PREFERRED EMBODIMENT

The detailed description of the present invention will be discussed in the following embodiments, which are not intended to limit the scope of the present invention, but can be adapted for other applications. While drawings are illustrated in detail, it is appreciated that the scale of each component may not be expressed exactly.

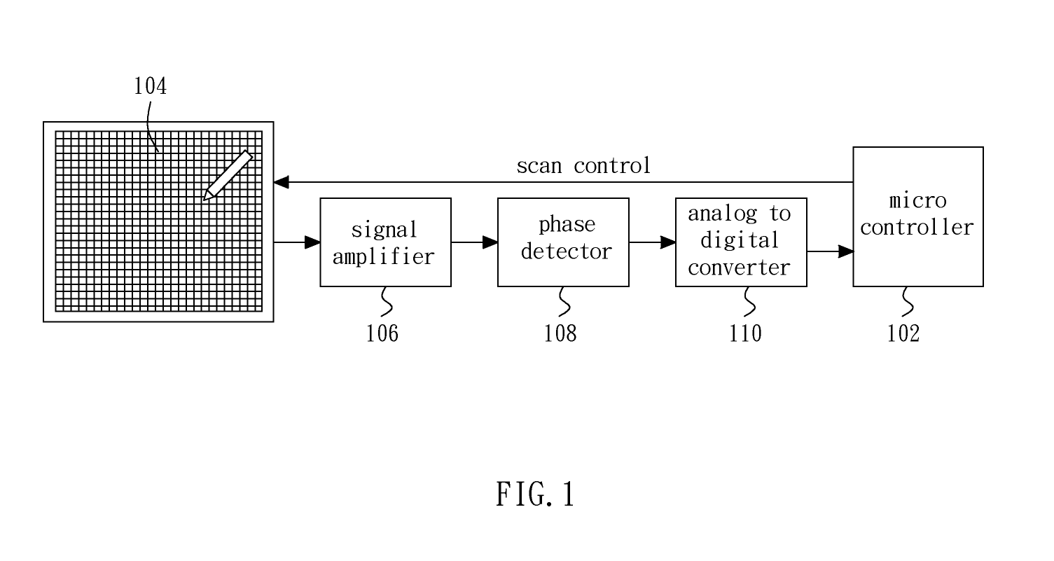

FIG. 1 shows a block diagram of an electromagnetic position detection apparatus according to one embodiment of the invention. The electromagnetic position detection apparatus comprises a micro controller 102, an antenna board 104 including a plurality of partially overlapped and parallel arranged along x and y axes antennas and sensor coils on a board or a substrate, and a signal processing circuit including a signal amplifier 106, a phase detector 108 and an analog to digital converter 110. The signal processing circuit is not limited to the components shown in FIG. 1, and could further include a filter and a rectifier, etc. It will be appreciated by those skilled in the art that various modifications may be made without departing from the scope of the present invention, which is intended to be limited solely by the appended claims. The antennas or sensor coils of the antenna board 104 connect to switches controlled by the micro controller 102 to switch the sensor coils in order to transmit and receive electromagnetic signals. The micro controller 102 controls a signal generating circuit and a selection circuit to switch and transmit signals through the antennas or sensor coils. The signals from the antennas or sensor coils resonate with the resonance circuits of the pointers. The resonance circuits of the pointers transmit signals back to the antennas or sensor coils when the antennas or sensor coils temporarily stop transmitting signals. The resonance circuits of the pointers and the antennas or sensor coils transmit and receive signals continuously and alternately. The signals received by the antennas or sensor coils are processed and analyzed by the signal processing circuit including the signal amplifier 106, the filter, the rectifier, the phase detector 108 and the analog to digital converter 110. The electromagnetic position detection apparatus comprises electromagnetic position detection apparatuses used with batteryless pointers or pointers with batteries. If the electromagnetic position detection apparatus is used with pointers with batteries, the antenna board further comprises power loops or loop coils for transmitting control signals. The power loops can be located around the antennas or sensor coils on the antenna board. When the pointers with batteries approach the antenna board 104, the micro controller 102 controls the power loops to transmit control signals to the pointers. The pointers then transmit signals to the antenna board 104. The micro controller 102 controls switches to switch antennas in order to transmit and receive electromagnetic signals. The signals received by the antennas or sensor coils are processed and analyzed by the signal amplifier 106, the filter, the phase detector 108 and the analog to digital converter 110.

When the pointer moves on the antenna board 104, the circuits of the pointers and the antennas or sensor coils transmit and receive signals continuously and alternately. The antennas or sensor coils on the trace of the pointer are switched by the micro controller 102 sequentially to transmit and receive signals continuously and alternately. The micro controller 102 sequentially switching the antennas or sensor coils is also referred to as scanning. The position detection of the pointers begins from detecting any signals from the pointers to completely calculating the coordinates of the pointers including x and y coordinates. The micro controller 102 controls a signal generating circuit and a selection circuit to sequentially switch the antennas or sensor coils to transmit and receive signals alternately to perform a full region scan, and thus any signal received by any antenna can be detected and processed. If the pointers are on the detection region of the antenna board 104, the antennas corresponding to the positions of the pointers will receive signals with maximum values, and thus the positions of the pointers can be roughly located. Then the micro controller 102 controls the signal generating circuit and the selection circuit to sequentially switch the antennas or sensor coils within a certain region with the position of the pointer as the center to transmit and receive signals alternately to perform a partial region scan. The partial region scan only switches the antennas or sensor coils adjacent the antennas or sensor coils receiving the signals with maximum values to transmit and receive signals. The coordinates of the pointers are located if signals with maximum values are received and the accurate coordinates of the pointers are calculated through further signal processing.

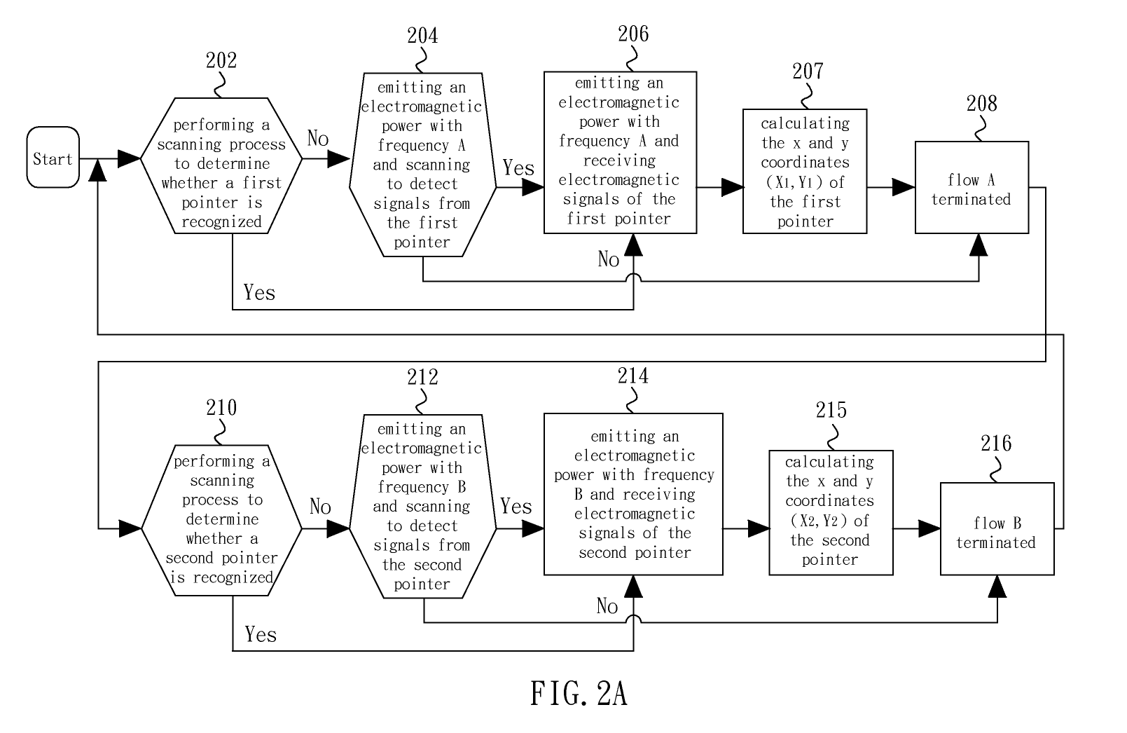

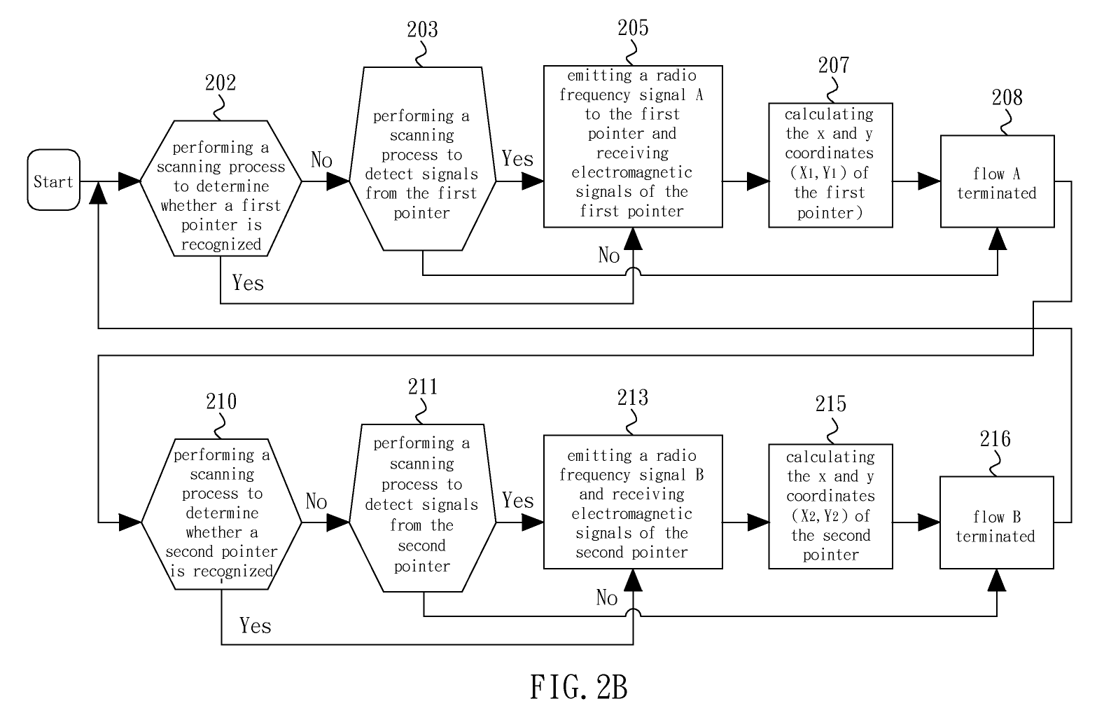

FIG. 2A shows a flow chart of a method for simultaneously operating multiple pointers on an electromagnetic position detection apparatus according to one embodiment of the present invention. First of all, in step 202, a scanning process is performed to determine whether a first pointer is recognized. If the first pointer is not recognized, then in step 204, an electromagnetic power with frequency A is emitted and the antennas along the x and y axes respectively are scanned to detect signals from the first pointer. If the first pointer is recognized, then in step 206, an electromagnetic power with frequency A is emitted and an electromagnetic signal of the first pointer is received. Next in step 207, the x and y coordinates (X₁,Y₁) of the first pointer are calculated, and flow A is terminated in step 208. If in step 204, no signals from the first pointer are detected after emitting the electromagnetic power with frequency A, then flow A is terminated in step 208. If in step 204, signals from the first pointer are detected after emitting the electromagnetic power with frequency A and scanning the antennas along the x and y axes respectively, then in step 206, an electromagnetic power with frequency A is emitted and an electromagnetic signal of the first pointer is received. Next in step 207, the x and y coordinates (X₁,Y₁) of the first pointer are calculated, and flow A is terminated in step 208.

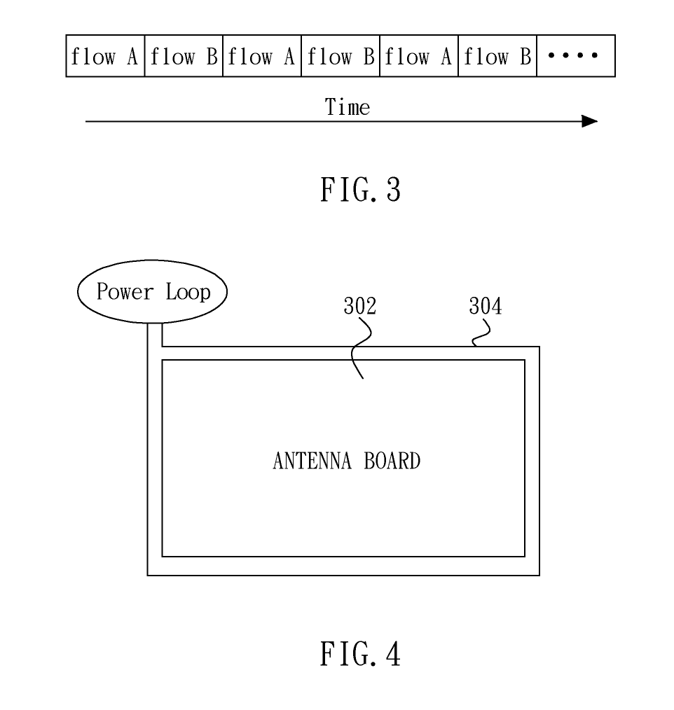

After the flow A is terminated, flow B starts. First of all, in step 210, a scanning process is performed to determine whether a second pointer is recognized. If the second pointer is not recognized, then in step 212, an electromagnetic power with frequency B is emitted and the antennas along the x and y axes respectively are scanned to detect signals from the second pointer. If the second pointer is recognized, then in step 214, an electromagnetic power with frequency B is emitted and an electromagnetic signal of the second pointer is received. Next in step 215, the x and y coordinates (X₂,Y₂) of the second pointer are calculated, and flow B is terminated in step 216. If in step 212, no signals from the second pointer are detected after emitting the electromagnetic power with frequency B, then flow B is terminated in step 216. If in step 212, signals from the second pointer are detected after emitting the electromagnetic power with frequency B and scanning the antennas along the x and y axes respectively, then in step 214, an electromagnetic power with frequency B is emitted and an electromagnetic signal of the second pointer is received. Next in step 215, the x and y coordinates (X₂,Y₂)of the second pointer are calculated, and flow B is terminated in step 216. After the flow B is terminated, the steps 202 to 208, or flow A, are performed again. After the steps 202 to 208, or flow A, is over, the steps 210 to 216, or flow B, are performed again. As shown in FIG. 3, flow A and flow B are alternately and repeatedly performed in order to simultaneously operate the first and the second pointers.

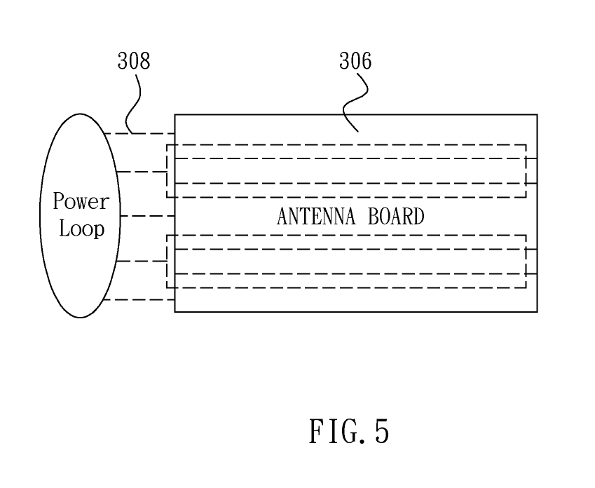

It is noted that the pointers emit signals with the same frequency. In order to make sure that only one pointer receives an electromagnetic power at one time, the emitting of the electromagnetic power must be controlled. Electromagnetic powers with two different frequencies are emitted for two separate pointers so that only one pointer receives an electromagnetic power at one time. Thus, only the pointer with a receiving frequency A can receive the electromagnetic power with frequency A, and the pointer with a receiving frequency B can receive the electromagnetic power with frequency B. Furthermore, the electromagnetic power can be emitted through the antennas on the antenna board or the power loops around the antennas. FIGS. 4 and 5 show two embodiments of power loops for emitting the electromagnetic power respectively. FIG. 4 shows that power loops 304 for emitting the electromagnetic power are located around the antennas and on the peripheral region of the antenna board 302. FIG. 5 shows that power loops 308 for emitting the electromagnetic power are extended from the antennas arranged along x and y axes of the antenna board 306.

FIG. 2B shows a flow chart of a method for simultaneously operating multiple pointers on an electromagnetic position detection apparatus according to another embodiment of the present invention. First of all, in step 202, whether a first pointer is recognized is determined. If the first pointer is not recognized, then in step 203, a scanning process on the antennas along the x and y axes respectively is performed to detect signals from the first pointer. If the first pointer is recognized, then in step 205, a radio frequency signal A is emitted to the first pointer and an electromagnetic signal of the first pointer is received. Next in step 207, the x and y coordinates (X₁,Y₁) of the first pointer are calculated, and flow A is terminated in step 208. If in step 203, signals from the first pointer are not detected, then flow A is terminated in step 208. If in step 203, signals from the first pointer are detected after the scanning process, then in step 205, a radio frequency signal A is emitted to the first pointer and an electromagnetic signal of the first pointer is received. Next in step 207, the x and y coordinates (X₁,Y₁) of the first pointer are calculated, and flow A is terminated in step 208.

After the flow A is terminated, flow B starts. First of all, in step 210, whether a second pointer is recognized is determined. If the second pointer is not recognized, then in step 211, a scanning process on the antennas along the x and y axes respectively is performed to detect signals from the second pointer. If the second pointer is recognized, then in step 213, a radio frequency signal B is emitted and an electromagnetic signal of the second pointer is received. Next in step 215, the x and y coordinates (X₂,Y₂)of the second pointer are calculated, and flow B is terminated in step 216. If in step 211, no signals from the second pointer are detected after the scanning process, then flow B is terminated in step 216. If in step 211, signals from the second pointer are detected after the scanning process on the antennas along the x and y axes, then in step 213, a radio frequency signal B is emitted and an electromagnetic signal of the second pointer is received. Next in step 215, the x and y coordinates (X₂,Y₂)of the second pointer are calculated, and flow B is terminated in step 216. After the flow B is terminated, the flow A is performed again. After the flow A is over, the flow B is performed again. As shown in FIG. 3, the flow A and the flow B are alternately and repeatedly performed in order to simultaneously operate the first and the second pointers. In order to make sure that only one pointer receives an electromagnetic power at one time, separate radio frequency signals are emitted to drive two separate pointers so that two pointers can be operated alternately. It is noted that the pointers emit signals with the same frequency. In order to make sure that only one of two pointers which emit signals with the same frequency emits signals at one time, different radio frequency signals are transmitted to the pointers. Thus, only the first pointer which is set to receive radio frequency signal A can emit signals at one time, and the second pointer which is set to receive radio frequency signal B can emit signals at another time.

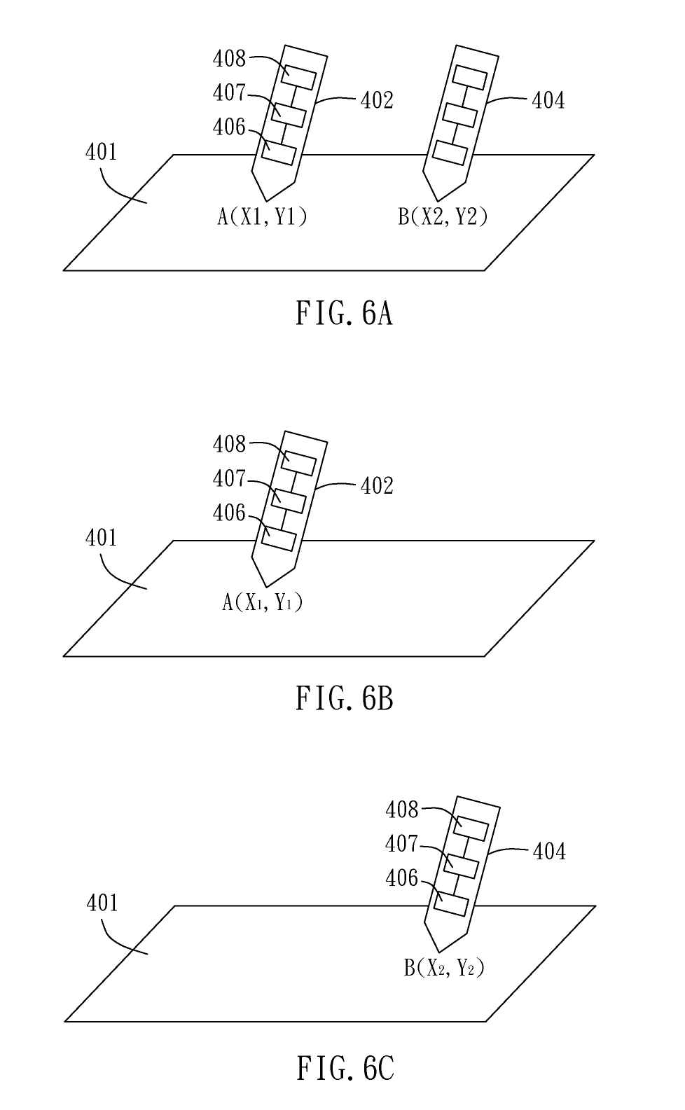

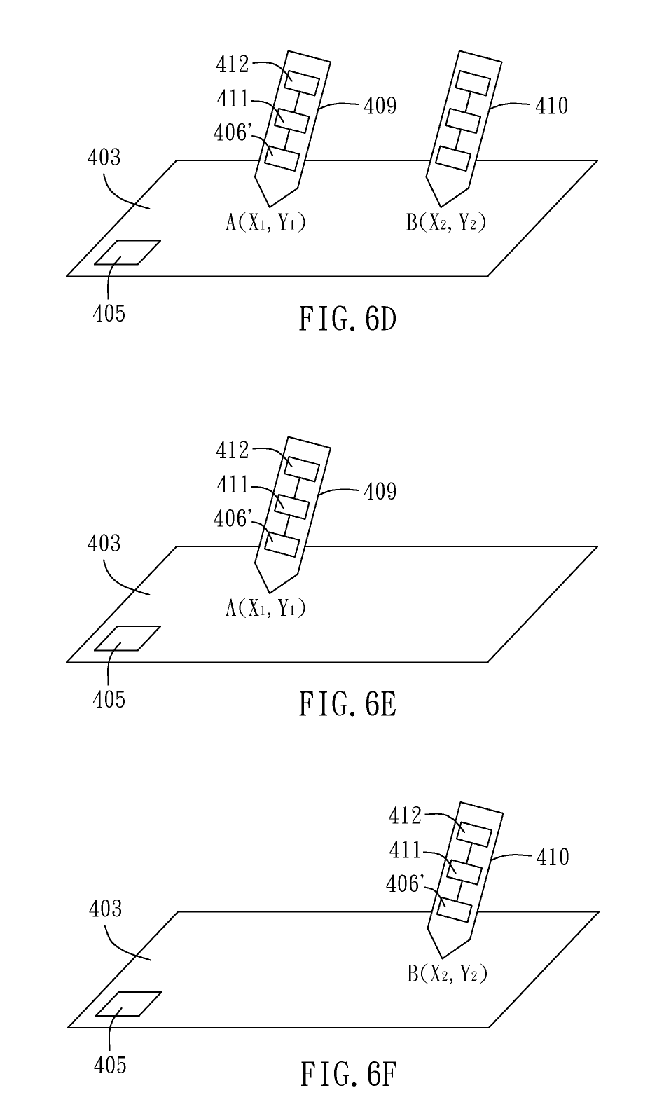

FIG. 6A shows a schematic view of two pointers 402 and 404 simultaneously operating on an electromagnetic position detection apparatus 401 according to one embodiment of the invention. The pointers 402 and 404 both have a signal transmitting coil 406, a rectifier circuit 407 and a power receiving coil 408. The power receiving coils 408 of the pointers 402 and 404 receive electromagnetic powers each with an individual frequency from the power loops 304 or 308. The rectifier circuit 407 processes the electromagnetic power and the signal transmitting coil 406 transmits signals to the electromagnetic position detection apparatus 401. The power receiving coils 408 of the pointers 402 and 404 are set to receive the electromagnetic powers with different frequencies respectively so that only one pointer receives the electromagnetic power at one time frame, but the signal transmitting coils 406 of the pointers 402 and 404 transmit signals with the same frequency. Corresponding to the flow chart shown in FIG. 2A, the electromagnetic position detection apparatus 401 recognizes the pointer 402 after full region and partial region scan processes in step 202. Then an electromagnetic power with frequency A is emitted and an electromagnetic signal of the pointer 402 is received in step 206. Next the x and y coordinates (X₁,Y₁) of the pointer 402 are calculated in step 207, and flow A is terminated in step 208. Then the pointer 404 is recognized after full region and partial region scan processes in step 210. Then an electromagnetic power with frequency B is emitted and an electromagnetic signal of the pointer 404 is received in step 214. Next the x and y coordinates (X₂,Y₂) of the pointer 404 are calculated in step 215, and flow B is terminated in step 216. As shown in FIG. 3, flow A and flow B are alternately and repeatedly performed in order to simultaneously and alternately operate the pointers 402 and 404.

FIG. 6B shows a schematic view of only pointer 402 operating on an electromagnetic position detection apparatus 401 according to one embodiment of the invention. Corresponding to the flow chart shown in FIG. 2A, the electromagnetic position detection apparatus 401 recognizes the pointer 402 after full region and partial region scan processes in step 202. Then an electromagnetic power with frequency A is emitted and an electromagnetic signal of the pointer 402 is received in step 206. Next the x and y coordinates (X₁,Y₁) of the pointer 402 are calculated in step 207, and flow A is terminated in step 208. Then the pointer 404 is not recognized after full region and partial region scan processes in step 210. Then an electromagnetic power with frequency B is emitted and the antennas along the x and y axes respectively are scanned to detect signals from the pointer 404 in step 212. Since the pointer 404 is not present, no electromagnetic signal from another pointer is received, and flow B is terminated. Even though no other pointer than pointer 402 is in operation, the steps shown in FIGS. 2A and 3 are continuously performed. If the pointer 404 joins operation later, the operation of the pointers 402 and 404 on the electromagnetic position detection apparatus 401 is the same as shown in FIG. 6A.

FIG. 6C shows a schematic view of only pointer 404 operating on an electromagnetic position detection apparatus 401 according to one embodiment of the invention. Corresponding to the flow chart shown in FIG. 2A, the electromagnetic position detection apparatus 401 does not recognize the pointer 402 after full region and partial region scan processes in step 202. Then, an electromagnetic power with frequency A is emitted and the antennas along the x and y axes respectively are scanned to detect signals from the pointer 402 in step 204. Since the pointer 402 is not present, no electromagnetic signal from the pointer 402 is received, and flow A is terminated. In flow B, the pointer 404 is recognized after full region and partial region scan processes in step 210. Then an electromagnetic power with frequency B is emitted and an electromagnetic signal of the pointer 404 is received in step 214. Next the x and y coordinates (X₂,Y₂) of the pointer 404 are calculated in step 215, and flow B is terminated in step 216. As shown in FIG. 3, flow A and flow B are alternately and repeatedly performed in order to simultaneously and alternately operate the pointers 402 and 404. Even though no other pointer than pointer 404 is in operation, the steps shown in FIGS. 2A and 3 are continuously performed. If the pointer 402 joins operation later, the operation of the pointers 402 and 404 on the electromagnetic position detection apparatus 401 is the same as shown in FIG. 6A.

FIG. 6D shows a schematic view of two pointers 409 and 410 simultaneously operating on an electromagnetic position detection apparatus 403 according to one embodiment of the invention. The electromagnetic position detection apparatus 403 includes a radio frequency signal transmitting device 405 to transmit radio frequency signals to the pointers 409 and 410. The radio frequency signal transmitting device 405 can be controlled by the micro controller. The pointers 409 and 410 both comprise a signal transmitting coil 406′, a controller circuit 411 and a radio frequency signal receiving device 412. The radio frequency signal receiving device 412 receives radio frequency signals from the radio frequency signal transmitting device 405 to drive the controller circuit 411. The controller circuit 411 controls the signal transmitting coil 406′ to transmit signals. The radio frequency signal receiving devices 412 of the pointers 409 and 410 receive individual radio frequencies from the radio frequency signal transmitting device 405 respectively, but the signal transmitting coils 406′ of the pointers 409 and 410 transmit signals with the same frequency. Corresponding to the flow chart shown in FIG. 2B, the electromagnetic position detection apparatus 403 recognizes the pointer 409 after full region and partial region scan processes in step 202. Then in step 205, a radio frequency signal A is emitted to the pointer 409 and an electromagnetic signal of the pointer 409 is received. Next in step 207, the x and y coordinates (X₁,Y₁) of the pointer 409 are calculated, and flow A is terminated in step 208. Then in step 210, the pointer 410 is recognized. Then in step 213, a radio frequency signal B is emitted and an electromagnetic signal of the pointer 410 is received. Next in step 215, the x and y coordinates (X₂,Y₂)of the pointer 410 are calculated, and flow B is terminated in step 216. As shown in FIG. 3, the flow A and the flow B are alternately and repeatedly performed in order to simultaneously operate the pointers 409 and 410.

FIG. 6E shows a schematic view of only pointer 409 operating on an electromagnetic position detection apparatus 403 according to one embodiment of the invention. Corresponding to the flow chart shown in FIG. 2B, the electromagnetic position detection apparatus 403 recognizes the pointer 409 after full region and partial region scan processes in step 202. Then in step 205, a radio frequency signal A is emitted to the pointer 409 and an electromagnetic signal of the pointer 409 is received. Next in step 207, the x and y coordinates (X₁,Y₁) of the pointer 409 are calculated, and flow A is terminated in step 208. Then in step 210, the pointer 410 is not recognized. Next in step 211, a scanning process on the antennas along the x and y axes respectively is performed to detect signals from the pointer 410. Since the pointer 410 is not present, no signals from the pointer 410 are detected after the scanning process, then flow B is terminated in step 216. Even though no other pointer than pointer 409 is in operation, the steps shown in FIGS. 2B and 3 are continuously performed. If the pointer 410 joins operation later, the operation of the pointers 409 and 410 on the electromagnetic position detection apparatus 403 is the same as shown in FIG. 6D.

FIG. 6F shows a schematic view of only pointer 410 operating on an electromagnetic position detection apparatus 403 according to one embodiment of the invention. Corresponding to the flow chart shown in FIG. 2B, the electromagnetic position detection apparatus 403 does not recognize the pointer 409 after full region and partial region scan processes in step 202. Next in step 203, a scanning process on the antennas along the x and y axes respectively is performed to detect signals from the pointer 409. Since the pointer 409 is not present, no signals from the pointer 409 are detected after the scanning process, then flow A is terminated in step 208. In flow B, the pointer 410 is recognized after full region and partial region scan processes in step 210. Then in step 213, a radio frequency signal B is emitted to the pointer 410 and an electromagnetic signal of the pointer 410 is received. Next in step 215, the x and y coordinates (X₂,Y₂) of the pointer 410 are calculated, and flow B is terminated in step 216. As shown in FIG. 3, the flow A and the flow B are alternately and repeatedly performed in order to simultaneously operate multiple pointers. Even though no other pointer than pointer 410 is in operation, the steps shown in FIGS. 2B and 3 are continuously performed. If the pointer 409 joins operation later, the operation of the pointers 409 and 410 on the electromagnetic position detection apparatus 403 is the same as shown in FIG. 6D.

Although the embodiments shown in FIGS. 2A, 2B and 3 involve simultaneous operation of two pointers, the method and apparatus of the invention are not limited to be performed and to be used with two pointers simultaneously. Through the programming of the firmware of the micro controller or the controller unit, the number of pointers used can be expanded. It will be appreciated by those skilled in the art that various modifications may be made without departing from the scope of the present invention, which is intended to be limited solely by the appended claims.

The invention uses the programming of the firmware of the micro controller to process signals transmitted and received between multiple pointers and an electromagnetic position detection apparatus via time divisional protocols such that only one pointer interacts with the electromagnetic position detection apparatus at one time frame to locate the coordinates of the pointer without mutual interferences between the pointers. Therefore, multiple pointers can be operated on the electromagnetic position detection apparatus without additional hardware components.

Although specific embodiments have been illustrated and described, it will be appreciated by those skilled in the art that various modifications may be made without departing from the scope of the present invention, which is intended to be limited solely by the appended claims.

What is claimed is:

1. A method for operating multiple pointers on an electromagnetic position detection apparatus, the method comprising:
(a) emitting an electromagnetic power with a first frequency and responsively receiving first electromagnetic signals from a first pointer;
(b) calculating coordinates of the first pointer based on the received first electromagnetic signals;
(c) emitting an electromagnetic power with a second frequency, after said emitting the electromagnetic power with the first frequency, and responsively receiving second electromagnetic signals from a second pointer;
(d) calculating coordinates of the second pointer based on the received second electromagnetic signals; and
(e) repeatedly performing said steps(a) through (d).

2. The method according to claim 1, wherein the first and second electromagnetic signals received from the first and second pointers are of the same frequency.

3. The method according to claim 1, wherein said steps (a) and (c) are performed according to a time divisional protocol such that only one of the first and second pointers interacts with the electromagnetic position detection apparatus at one time frame to calculate the coordinates of the first and second pointers without mutual interference between the first and second pointers.

4. The method according to claim 1, further comprising:
(f) performing a first scanning process to determine whether a first pointer is recognized, prior to said step (a), wherein said step (a) is performed if the first pointer is recognized; and
(g) performing a second scanning process to determine whether a second pointer is recognized, prior to said step (c), wherein said step (c) is performed if the second pointer is recognized.

5. The method according to claim 4, further comprising:
(h) emitting an electromagnetic power with the first frequency and performing a scanning process to detect signals from the first pointer if the first pointer is not recognized.

6. The method according to claim 5, wherein when the signals from the first pointer are detected after emitting the electromagnetic power with the first frequency and performing the scanning process, the steps (a) to (e) and (g) are performed.

7. The method according to claim 5, wherein when the signals from the first pointer are not detected after emitting the electromagnetic power with the first frequency and performing the scanning process, the steps (c) to (e) and (g) are performed.

8. The method according to claim 4 further comprising:
(i) emitting an electromagnetic power with the second frequency and performing a scanning process to detect signals from the second pointer if the second pointer is not recognized.

9. The method according to claim 8, wherein when the signals from the second pointer are detected after emitting the electromagnetic power with the second frequency and performing the scanning process, the steps (c) to (e) are performed.

10. The method according to claim 8, wherein when the signals from the second pointer are not detected after emitting the electromagnetic power with the second frequency and performing the scanning process, the steps (a) to (e) are performed.

11. The method according to claim 1, wherein the electromagnetic powers with the first and second frequencies are emitted by power loops extended from sensor coils of an antenna board of the electromagnetic position detection apparatus.

12. The method according to claim 1, wherein the electromagnetic powers with the first and second frequencies are emitted by power loops located around sensor coils and on the peripheral region of the antenna board of the electromagnetic position detection apparatus.

13. An electromagnetic position detection system for operating multiple pointers thereon, the system comprising:
a plurality of sensor coils on an antenna board;
at least two pointers transmitting signals to the sensor coils with a same frequency and receiving electromagnetic powers with different frequencies;
a micro controller controlling the sensor coils to receive the signals of the same frequency and to emit the electromagnetic powers of the different frequencies, wherein the micro controller sequentially controls the sensor coils to alternately emit the electromagnetic powers with the different frequencies to the pointers, wherein the pointers are set to receive the electromagnetic powers with the different frequencies so that only one of the pointers receives the electromagnetic power at one time frame; and
a signal processing circuit processing and analyzing the signals received by the sensor coils, and transmitting the processed signals to the micro controller to calculate coordinates of the pointers.

14. The system according to claim 13, wherein the pointers are set to receive the electromagnetic powers with the different frequencies so that only one of the pointers transmits the signal with the same frequency to the sensor coils at the one time frame.

15. The system according to claim 13, wherein the electromagnetic powers are emitted by power loops extended from the sensor coils of the antenna board.

16. The system according to claim 13, wherein the electromagnetic powers are emitted by power loops located around the sensor coils and on the peripheral region of the antenna board.

17. The system according to claim 13, wherein the pointers comprise batteryless pointers.

18. The system according to claim 13, wherein the pointers comprise pointers with batteries.

19. An electromagnetic position detection system for operating multiple pointers thereon, the system comprising:
a plurality of sensor coils on a substrate;
at least two pointers transmitting signals to the sensor coils with a same frequency and receiving radio frequency signals with different frequencies;
a micro controller controlling the sensor coils to receive the signals of the same frequency from the at least two pointers, wherein the micro controller controls a radio frequency signal transmitting device to alternately emit the radio frequency signals with the different frequencies to the pointers so that only one of the pointers transmits the signal of the same frequency at one time frame; and
a signal processing circuit processing and analyzing the signals of the same frequency received by the sensor coils, and transmitting the processed signals to the micro controller to calculate coordinates of the pointers.

20. The system according to claim 19, wherein the pointers are configured to receive the radio frequency signals with the different frequencies so that only one of the pointers transmits the signal with the same frequency to the sensor coils at the one time frame.
